(19) United States
(12) Patent Application Publication
(10) Pub. No.: US 2023/0283651 A1
(43) Pub. Date: Sep. 7, 2023

(54) Multimedia system information interaction mechanism and network transmission method

(71) Applicant: SHANGHAI JIAO TONG UNIVERSITY, Shanghai (JP)

(72) Inventors: Wenjun Zhang, Shanghai (CN); Yiling Xu, Shanghai (CN); Ning Zhuang, Shanghai (CN); Hao Chen, Shanghai (CN); Yanfeng Wang, Shanghai (CN); Jun Sun, Shanghai (CN); Ning Liu, Shanghai (CN)

(73) Assignee: SHANGHAI JIAO TONG UNIVERSITY, Shanghai (CN)

(21) Appl. No.: 16/075,106

(22) PCT Filed: Jan. 25, 2017
(86) PCT No.: PCT/CN2017/072558

§ 371 Date: Aug. 29, 2022

(30) Foreign Application Priority Data
Feb. 2, 2016 (CN) 201610074442.X
Feb. 2, 2016 (CN) 201610074851.X
Feb. 2, 2016 (CN) 201610107748.0

(51) Int. Cl. H04L 65/75; H04L 47/34

(52) U.S. Cl. CPC H04L 65/75; H04L 47/34

(57) ABSTRACT

The present invention provides two forms of information interaction mechanisms and network transmission methods in a multimedia system. One is implementing bidirectional quick information interaction by using an interaction message body, so that the defect that there is no efficient and flexible bidirectional information interaction mechanism in existing media transmission systems can be overcome, and the mechanism is applicable to all media transmission systems. The other one is simplifying the size of protocol format header data for a simplest data packet forced by a protocol transmission format, so that the protocol format is quickly adapted to quick information interaction. The simplifying the size of protocol format header data can overcome the defect that there is no efficient bidirectional quick information interaction mechanism in the existing media transmission systems. In addition, an optimized transmission mechanism for a still image in a video stream is provided.

### CROSS REFERENCE OF RELATED APPLICATION

This is a U.S. National Stage under 35 U.S.C 371 of the International Application PCT/CN2017/072558, filed Jan. 25, 2017, which claims priority under 35 U.S.C. 119(a-d) to CN201610074851, filed Feb. 2, 2016; CN 201610074442, filed Feb. 2, 2016; and CN201610107748, filed Feb. 26, 2016

### BACKGROUND OF THE PRESENT INVENTION

### Field of Invention

The present invention relates to an information interaction mechanism in a multimedia system, and more accurately, to an information interaction mechanism, a network transmission method, and an optimized transmission mechanism in a multimedia system.

### Description of Related Arts

With the rise of new-generation application consumption modes such as cloud computing, the Internet of Things, and smart wearable devices, one-way data transmission based on conventional audio and video media has failed to meet the needs of various applications. A new data transmission format for transmission in a new-generation multimedia transmission system should include various possible data types, and both communication parties need to support bidirectional communication to implement different service logic and service flows.

Real-time information interaction has increasingly become an important trend of data exchange in a future multimedia system. A user needs to upload interaction data to a server in real time, so that the server can learn the current operation and working status of the user. On the other hand, the server analyzes and calculates the learned information, makes a quick response and delivers a processing result to the user in real time. The characteristic thereof is that the data volume of information each time is small, but the interaction frequency is very high, and the real-time requirement for uploading and pushing down is very high. Therefore, the message format should be simple, and the smaller the overheads, the better. Therefore, the format design and network transmission method design of such quick information interaction appear to be particularly important.

The non-real-time information interaction is mainly resource request response interaction information, and the objective thereof is to meet the requirement that the user actively requests for resource data of a server end based on the needs of the user. The characteristic thereof is session-type interaction and non-real-time frequent interactions, but support of a communication link from a client to the server end and effective responses of the server are needed. The process is that after receiving a program stream, the user obtains available resource information provided by the program stream, where the available resource information includes a description file and media data, and then the user requests the server end for corresponding data, and after receiving the request, the server verifies the validity of the request, and sends confirmation information and transmits the data if the request is valid, or otherwise, sends failure information. Efficient multimedia transmission systems should meet more lightweight request-response interaction manners, while multimedia-oriented interactive formats should also be supported.

Upon search, the Chinese invention patent CN200310123710.5 discloses a system, which relates to a program specific information data structure that facilitates communication between program content and program guide data with attached multimedia objects including audio, videos, animations, still images, the Internet, emails, text and other types of data. The data structure supports one-way communication applications, e.g. passive viewing, and bidirectional communication applications, e.g. interactive type functions. A decoder processes packetized program data and program specific information containing ancillary description information including multimedia object types, locations and other descriptive indicators. These indicators are used for acquiring and decoding multimedia objects obtained from different signal sources, for presentation in composite video images representing video program content or program guides. Additional ancillary location and acquisition description information enable acquisition of supplementary program specific information units and program content data. The patent still fails to well resolve the problem that there is no efficient bidirectional quick information interaction in existing media transmission systems.

In addition, in current network traffic, multimedia services, especially video services, account for most of the traffic of the Internet. How to effectively reduce the bandwidth occupied by video data in network transmission has become a new research hotspot.

Video coding technologies such as H.264 and HEVC, which are widely used in the market at present adopt technologies such as intra-frame coding and inter-frame coding, and have extremely high coding compression ratios and coding efficiencies, and basically do not affect the user experience. Video data on which H.264 compression is performed needs fewer bandwidths in the network transmission process, and is more economical. Therefore, H.264 has achieved great success once released. By the end of 2011, 80% of videos have been encoded by using H.264.

H.264 and HEVC inter-frame coding technologies are based on technologies such as motion estimation and motion compensation, and the difference between front and rear frames is encoded by using the similarity between the front and rear frames of a video, and therefore encoding can be performed by using a relatively low code rate. However, for some specific video application scenarios, such as remote desktop and remote video surveillance, performing encoding by using H.264 and HEVC still has some shortcomings. The main difference between such a scenario and a normal video application is that the video content remains unchanged or changes very little for most of the time. In the time period when the video content remains unchanged, even if the inter-frame coding technology such as H.264 is used, each frame of the video needs to be encoded, and therefore bandwidth occupation and traffic waste are still caused.

Upon search, the Chinese invention patent with the publication number CN101889447A discloses a method for encoding data, the method including: a. capturing data of a video stream, where the video stream includes data of a plurality of successive video frames; b. capturing one or more still images, where each still image is captured at a random interval of time relative to the video stream; c. embedding each still image within the video frames in series, thereby forming a combined data stream; d. signaling a presence of a high resolution still image by using a new profile definition in a modified sequence parameter set; e. encoding the combined data stream; and f. sending the encoded combined data stream as a single-layer transmission.

For another example, the Chinese invention patent CN101878649A also discloses extending an AVC standard in order to encode high-resolution digital still images in parallel with a video.

However, these patents still fail to resolve the foregoing problems.

### SUMMARY OF THE PRESENT INVENTION

With respect to the defects in the prior art, the objective of the present invention is to provide an information interaction mechanism and a network transmission method in a multimedia system, to overcome the defect that there is no efficient bidirectional quick information interaction mechanism in existing media transmission systems, and also provide an optimized transmission mechanism for a still image in a video stream, to reduce bandwidth occupation and traffic waste caused by video coding when an image remains unchanged in a video stream.

To achieve the foregoing objective, the present invention is implemented by using the following technical solutions.

According to a first aspect of the present invention, an information interaction mechanism in a multimedia system is provided, where the mechanism implements bidirectional quick information interaction by using the following message, and the message includes:

a message identification field;

a message version number field;

a message length identification field; and

a payload data segment of current message payload.

Further, the payload data segment including the current message payload includes the following field:

a message content category identification field; or a reserved field is further included.

Furthermore, the payload data segment including and identifying the current message payload further includes the following fields:

a field identifying a sequence number of the message;

a field identifying a sequence number of a message associated with the message;

a field identifying a feedback state;

a field identifying a format of content of the message;

a field identifying a length of content data of the message; and

a byte data segment identifying current interaction information.

In the present invention, the message is session-type interaction, and a user request and a system response format are organically unified, and a server and a client supporting the mechanism can implement the multimedia-oriented lightweight interaction application of the resource request response type even without the interface of the http protocol. This brings enormous convenience to media network transmission.

With the flexible message body format mechanism provided in the present invention, a proper specific message format can be designed with respect to specific requirements of various media services. A quick and efficient transmission protocol combined with a flexible and customizable message body format enables the present invention to be applicable to all media transmission systems.

According to a second aspect of the present invention, a network transmission method that is used for interaction information data in a multimedia system and that is based on the foregoing information interaction mechanism in a multimedia system is provided, and the method includes:

encapsulating, by a terminal device, a message into a data packet based on a preset message format;

transmitting the data packet to a network server;

correspondingly obtaining, by the server based on the preset message format, the data packet to obtain payload data, and performing corresponding processing and responses; and

following, by the server to the terminal device, the foregoing corresponding steps.

The network transmission method according to the present invention further includes:

step a: encapsulating, by a network terminal device, a message body “PRR_data_byte” field based on a pre-customized format of a specific bit payload data segment in an extensible message format or a user-defined format of the message body;

step b: encapsulating, by the network terminal device, the entire message based on an interaction message body format;

step c: encapsulating, by the network terminal device based on a definition of a format of the selected network communication protocol “payload”, the message into the protocol “payload”;

step d: generating, by the network terminal device, one or more packet network transmission data packets based on the protocol format;

step e: obtaining, by a network server after receiving packet data packets submitted by one or more clients, a complete protocol level “payload” data segment based on protocol headers of the data packets;

step f: obtaining, by the network server based on the format of the selected network protocol “payload”, a complete message body data segment;

step g: obtaining, by the network server based on a message header, a bit payload data segment of the message body (that is, data included in the “PRR_data_byte” field); and

step h: obtaining, by the network server based on a message-defined format or a user-defined format, the bit payload data segment (that is, the data included in the “PRR_data_byte” field), and performing corresponding processing and responses.

Communication from a server end to the network terminal device also follows the steps. The data format and application method satisfy the requirement of network bidirectional communication.

According to a third aspect of the present invention, a quick information interaction mechanism in a multimedia system is provided, and the mechanism includes:

simplifying a size of protocol format header data for a simplest data packet forced by a protocol transmission format, so that the protocol format is quickly adapted to quick information interaction, where

the simplifying a size of protocol format header data is simplifying any one, two, or three of three fields: a data packet identifier (Packet_id), a timestamp (Timestamp), and a data packet sequence number (Packet_sequence_number), and indicating, by using an indicator with a relatively small number of bytes, whether the three fields are used, to make the number of bytes of the protocol format header data become smaller, thereby making the protocol format quickly adapted to quick information interaction.

Specifically, the simplifying a size of protocol format header data refers to: selecting a reserved field in an original protocol transmission format as a flag bit, and providing a choice of whether using data whose three fields: Packet_id, Timestamp, and Packet_sequence_number are simplified, to make the number of bytes of the protocol format header data become smaller, thereby making the protocol format quickly adapted to quick information interaction.

Further, the types of the indicator are not limited to a letter and a reference sign.

Further, the indicator uses T, P, and F identification fields, each of which occupies one byte.

Further, the simplifying a size of protocol format header data is specifically: selecting the reserved field in the original protocol transmission format and separately modifying it into a T identification field.

T: timestamp_flag, a timestamp identifier; if T is set to 1, a timestamp field is used, and if T is set to 0, the timestamp field is not used; when interaction information has strong instantaneity, that is, once a client or a server end receives the information, a response is made, the field is set to 0, and the precondition is providing a reliable underlying communication protocol.

Further, the simplifying a size of protocol format header data is specifically: selecting the reserved field in the original protocol transmission format and separately modifying it into a P identification field.

P: packet_id_flag, a data packet identifier; if P is set to 1, a packet_id field is used, and if P is set to 0, the packet_id field is not used; when the amount of payload information is relatively small and a data packet can be placed for transmission, or when a data packet is delivered to the underlying protocol for implementation, the field is set to 0, and the precondition is providing a reliable underlying communication protocol.

Further, the simplifying a size of protocol format header data is specifically: selecting the reserved field in the original protocol transmission format and separately modifying it into an F identification field.

F: fragmentation_flag, a data packet identifier; if F is set to 1, a packet_sequence_number field is used, and if F is set to 0, the packet_sequence_number field is not used; the field is used in combination with the “P” field; when the condition of setting the “P” field to 0 is met, this field is set to 0.

In the present invention, the foregoing simplifying a size of protocol format header data greatly reduces the number of bytes, thereby improving the speed of network transmission and adapting to quick network information interaction. Further, under the precondition of quick network information interaction, a quick message interaction format and a bidirectional resource quick request response message format can be designed with respect to specific requirements of various media services. A quick and efficient transmission protocol combined with a flexible and customizable message body format enables the present invention to be applicable to all media transmission systems.

Regarding the quick information interaction, a message entity that performs quick interaction is transmitted in a signaling mode.

Further, regarding the quick information interaction, the information entity that performs quick interaction includes the following fields:

a message identification field of a real-time interaction message;

a version number field of a message;

a message length identification field;

an extension field; and

a data segment identifying current message payload.

Furthermore, different types of message payload have different formats, where

real-time interaction message payload includes the following fields:

an extended flag bit field, used for indicating whether a current message signaling payload part includes an extensible data part;

a field identifying the number of pieces of interaction data included in the message signaling;

a type identifying current interaction information;

a field identifying a length of current interaction data;

a byte data segment identifying the current interaction information; and

a data format data segment for user definition or further extension; and

resource request response message payload includes the following fields:

a resource request method identification field, used for indicating a method for requesting for a resource by a current user; and

an extended flag bit field, used for indicating whether a current message signaling payload part includes an extensible data part.

Regarding the foregoing real-time interaction message payload, in the present invention, a common format thereof is predefined, and a definition of a specific message format is preset. The resource request response message is session-type interaction, and a user request and a system response format are organically unified, and a server and a client supporting the mechanism can implement the multimedia-oriented lightweight interaction application of the resource request response type even without the interface of the http protocol. This brings enormous convenience to media network transmission.

According to a fourth aspect of the present invention, a network transmission method that is used for interaction information data in a multimedia system and that is based on the foregoing quick information interaction mechanism in a multimedia system is provided is provided, and the method includes:

step a: encapsulating, by a network terminal device, a message body “payload” field based on a pre-defined format of a quick interaction message payload data segment (payload) or a user-defined payload format of the message body;

step b: encapsulating, by the network terminal device, the entire message based on a quick interaction message body format;

step c: encapsulating, by the network terminal device, the message into the protocol “payload” based on a definition of an MMT (ISO/IEC 23008-1) original protocol “payload” format;

step d: generating, by the network terminal device, one or more packet network transmission data packets based on the protocol format;

step e: obtaining, by a network server after receiving packet data packets submitted by one or more clients, a complete protocol level “payload” data segment based on protocol headers of the data packets;

step f: obtaining, by the network server based on the format of the protocol “payload”, a complete message body data segment;

step g: obtaining, by the network server based on a definition of a message header, a “payload” data segment of the message body; and

step h: obtaining, by the network server based on a message-defined or user-defined format, the message “payload” data segment, and performing corresponding processing and responses.

Communication from a server end to the network terminal device also follows the foregoing steps. The data format and application method satisfy the requirement of network bidirectional communication.

According to a Fifth Aspect of the Present Invention, an Optimized Transmission Mechanism for a Still Image in a Video Stream is Provided.

Compared with a mechanism in which a flag bit is added to still and unchanged frame data of a previous frame of image, and only information of the flag bit is transmitted and the frame data is not transmitted, the mechanism resolves the problem of bandwidth occupation and traffic waste brought by a still image frame in streaming media video transmission.

Specifically, with respect to the existing video transmission header format, the optimized transmission mechanism for a still image in a video stream includes:

disposing a video image still frame flag bit in a transmission header or signaling;

in video transmission, for a data packet corresponding to a still video frame image, sending only video still frame flag bit information in the header or signaling, and discarding corresponding still frame data; and reestablishing, by a client after receiving the video still frame flag bit, a current frame of image by using a previous frame of image.

In a preferred implementation, the disposing a video still frame flag bit in a transmission header or signaling refers to: taking a bit from a reserved field of an MMTP header as a video still frame flag bit for indicating that frame data corresponding to the current MMTP packet is the same as a previous frame.

In a preferred implementation, the disposing a video still frame flag bit in a transmission header or signaling refers to: using a priority field in a DU header, and taking a specific value to indicate that frame data corresponding to the current MMTP packet is the same as a previous frame.

Compared with the prior art, the present invention has the following beneficial effects:
1. By using the technical solutions of the first and second aspects of the present invention, the information interaction mechanism can design a unified interactive data transmission format for the characteristics of various different interactive data, and by using a unified interactive data transmission step, both the communication parties can greatly reduce the overheads brought by adapting to different types of data; further, the “payload” data segment in the message body is also allowed to be user-defined, and the reserved field in the message header is combined, so that system extension can be conveniently implemented. The present invention can effectively improve the transmission efficiency of a media network.
2. By using the technical solutions of the third and fourth aspects of the present invention, the quick information interaction mechanism can design a unified interactive data transmission format for the characteristics of various different interactive data, and by using a unified interactive data transmission step, both the communication parties can greatly reduce the overheads brought by adapting to different types of data; further, the “payload” data segment in the message body is also allowed to be user-defined, and the reserved field in the message header is combined, so that system extension can be conveniently implemented. The present invention can effectively improve the transmission efficiency of a media network.
3. By using the technical solution of the fifth aspect of the present invention, for the header or signaling of current video data transmission, such as an MMTP header or a DU header, a corresponding still frame flag bit is disposed, and use of network bandwidth is reduced by using a method in which only the flag bit is transmitted but corresponding frame data is not transmitted, so as to resolve the problem of bandwidth occupation and traffic waste brought by a still image frame in streaming media video transmission.

### BRIEF DESCRIPTION OF THE DRAWINGS

Other features, objectives, and advantages of the present invention will become more apparent by reading detailed descriptions of non-limitative embodiments made with reference to the following accompanying drawings:

FIG. 1 is a schematic diagram of application of an interaction message in Embodiment 1 of the present invention;

FIG. 2 is a frame of a flow of message transmission and obtaining in Embodiment 2 of the present invention;

FIG. 3 is a schematic diagram of a simplest data packet format forced by an MMTP original protocol transmission format in Embodiment 2 of the present invention;

FIG. 4 is a schematic diagram of application of a real-time interaction message in Embodiment 2 of the present invention;

FIG. 5 is a schematic diagram of a simplified minimum data header format in Embodiment 2 of the present invention;

FIG. 6 is a schematic diagram of application of a resource request response message in Embodiment 2 of the present invention;

FIG. 7 is a schematic diagram of a header data format of existing payload of an MMT in Embodiment 2 of the present invention;

FIG. 8 is a schematic diagram of using a reserved field in an MMTP header as a still frame flag bit in Embodiment 3 of the present invention; and

FIG. 9 is a schematic diagram of using a priority field in a DU header in Embodiment 3 of the present invention.

### DETAILED DESCRIPTION OF THE PREFERRED EMBODIMENT

The embodiments of the present invention are described in detail below. The embodiments are implemented on the premise of the technical solutions of the present invention, and the detailed implementation and the specific operation process are provided. It should be noted that, a person of ordinary skill in the art may further make several transformations and improvements without departing from the conception of the present invention, and these all fall within the protection scope of the present invention.

### Embodiment 1

This embodiment provides an information interaction mechanism in a multimedia transmission system, to overcome the defect that there is no efficient bidirectional quick information interaction mechanism in existing media transmission systems. The mechanism designs a unified interactive data transmission format, and the overheads brought by adapting to different types of data are reduced by using a unified interactive data transmission step.

The implementation details of this embodiment are described below by using examples. In some implementations of this embodiment, the interaction information body includes the following fields (as shown in Table 3):

a message identification field (message_id), used for identifying an identification code of the message;

a message version number field (version), used for identifying a version number of the message;

a message length identification field (length), used for identifying a length of the message; and

a payload data segment (message_payload) of current message payload, including and identifying payload of the message.

Further, in some implementations of this embodiment, the payload data segment includes the following fields:

a message content category identification field (PRR_type), at least for identifying whether the message is located in an uplink state or a downlink state between a server and a client; optionally, a reserved field (reserved) is further included, at least for identifying an information reservation function.

The bit length and the number of assigned values of the reserved field are not limited, and are preferably determined based on a bit number difference between an integer multiple of a bit number (one byte is 8 bits) within a byte and a bit number of the message content category identification field; as shown in Table 3, there are 8 bits within the byte, and the PRR_type occupies one bit; in this embodiment, the reserved field is set to have 7 bits, and “1111111” is assigned to the reserved field; an integer multiple of 8 is set for rounding, to facilitate information processing.

The message content category identification field identifies the uplink or the downlink respectively by using different assigned values. The message content category identification field identifies the uplink state by using an assigned value 0 and identifies the downlink state by using an assigned value 1, as shown in the following Table 1 of values of the PRR_type field.

TABLE 1
Values of the PRR_type field

| Value | Operation |
|---|---|
| 0 | POST uplink transmission |
| 1 | POST downlink transmission |

Furthermore, when the message content category identification field is the uplink state, that is, in a form corresponding to the assigned value “0” in this embodiment, the message includes:

a field identifying a sequence number of the message, that is, a message uplink sequence number identification field, used for identifying an uplink sequence number of the message;

a field identifying a format of content of the message, where the content format field is used for identifying a format of an uplink byte data segment;

a field identifying a length of content data of the message, where the content length field is used for identifying a length of the uplink byte data segment; and

a byte data segment of current interaction information, that is, the uplink byte data segment, including a byte stream currently interactively located in the uplink state.

Furthermore, when the message content category identification field is the downlink state, that is, in a form corresponding to the assigned value “1” in this embodiment, the message includes:

a field identifying a sequence number of a message associated with the message, that is, a message downlink sequence number identification field, used for identifying a downlink sequence number of the message; and

a feedback state field, that is, a downlink byte data segment, identifying, by using the feedback state field, and including a byte stream currently interactively located in the downlink state.

The downlink sequence number is associated with the uplink sequence number, and the association manner includes that the sequence numbers are same and correspond in a preset manner during uplink and downlink.

TABLE 2
Values of the status_number field

| Value | Operation |
|---|---|
| 0x00 | POST uplink information transmission fails, |
| | and reception is not completed within a preset time |
| 0x01 | POST uplink information transmission succeeds |
| 0x02 | POST uplink information transmission succeeds, |
| | and the message body includes feedback data |
| 0x03 to 0x7F | ISO standard reservation |
| 0x80 to 0xFF | Private field reservation |

In this embodiment, as shown in the foregoing Table 2, the feedback state field identifies at least three feedback states respectively by using different assigned values, that is, the three feedback states corresponding to 0x00, 0x01, and 0x02 in Table 2, and the states are respectively:

a first feedback state: an information uplink transmission failure, at least including a case in which reception is not completed within a preset time;

a second feedback state: an information uplink transmission success; and

a third feedback state: an information uplink transmission success, where the message includes the byte stream in the downlink, and the downlink byte stream may be understood as a type of feedback data.

In this embodiment, in addition to the foregoing three feedback states, more preferably, a fourth feedback state: ISO standard reservation and a fifth feedback state: private field reservation are further provided; as a reserved feedback state, the reserved feedback state includes any one, two, or more types. A correspondence between feedback states and assigned values can be learned from Table 2.

Furthermore, when the field identifying the feedback state is under the third feedback state, that is, in a form corresponding to the assigned value “0x02” in this embodiment (the value assigned to the feedback state field may be based on values of status codes of the standard Hypertext Transfer Protocol (HTTP) protocol, to keep good compatibility), the message includes

a byte data segment identifying current interaction information, that is, the currently interactive downlink byte content;

a field identifying a format of content of the message, and a field for identifying a format of content of the downlink byte stream; and

a field identifying a length of content data of the message, and a field for identifying a length of content of the downlink byte stream.

In conclusion, for the structure of the entire data format in the message in the present invention, reference may be made to the following Table 3 of interaction message formats.

TABLE 3
Interaction message format table

| Syntax | Value | Bit number | Format |
|---|---|---|---|
| PRR_message ( ) { | | | |
| message_id | | 16 | uimsbf |
| version | | 8 | uimsbf |
| length | | 32 | uimsbf |
| message_payload { | | | |
| reserved | ‘111 1111’ | 7 | bslbf |
| PRR_type | | 1 | bslbf |
| if(PRR_type == 0) { | | | |
| POST_serial_number | | 8 | uimsbf |
| mime_type( ) | | | |
| PRR_data_length | N1 | 16 | uimsbf |
| for(j == 0; j < N1; j++) | | | |
| } | | 8 | uimsbf |
| PRR_data_byte | | | |
| } | | | |
| } | | | uimsbf |
| else if(PRR_type == 1) { | | | uimsbf |
| Response_serial_number | | 8 | |
| status_number | | 8 | |
| if(status_number == 0x02){ | N2 | | uimsbf |
| mime_type( ) | | | |
| PRR_data_length | | 16 | uimsbf |
| for(j == 0; j < N2; j++) | | | |
| { | | 8 | |
| PRR_data_byte | | | |
| } | | | |
| } | | | |
| } | | | |
| } | | | |
| } | | | |

In Table 3, Uimsbf represents an unsigned integer, that is, “unsigned integer, most significant bit first”, and the numbers represent the number of bits occupied by the data element. Bslbf represents a bit string, that is, “Bit string, left bit first”.

It should be noted that Table 3 shows only a preferred manner of this embodiment of the present invention, and does not constitute a limitation to fields, data, lengths of content, positions, and formats.

Based on the foregoing information interaction mechanism in a multimedia transmission system, this embodiment further provides a network transmission method for interaction information data. In an implementation, the network transmission method for message data in this embodiment is applied between a network terminal device and a network server, and specifically includes the following steps:

Step a: The network terminal device encapsulates a message body “PRR_data_byte” field based on a pre-customized format of a specific bit payload data segment in an interaction message body format or a user-defined format of the message body.

Step b: The network terminal device encapsulates the entire message based on the interaction message body format.

Step c: The network terminal device encapsulates the message into the protocol “payload” based on a definition of a format of the selected network communication protocol “payload”.

Step d: The network terminal device generates one or more packet network transmission data packets based on the protocol format.

Step e: After receiving packet data packets submitted by one or more clients, the network server obtains, based on protocol headers of the data packets, a complete protocol level “payload” data segment.

Step f: The network server obtains, based on the format of the selected network protocol “payload”, a complete message body data segment.

Step g: The network server obtains, based on a message header, a bit payload data segment of the message body (that is, data included in the “PRR_data_byte” field).

Step h: The network server parses, based on a message-defined format or a user-defined format, the bit payload data segment (that is, the data included in the “PRR_data_byte” field), and performs corresponding processing and responses.

Communication from a server end to the network terminal device also follows the steps. The data format and application method satisfy the requirement of network bidirectional communication.

In an implementation, steps for implementing message interaction are described by using an example of this embodiment in which message content of a user-defined json format is transmitted by using the foregoing message format. This embodiment has good scalability and flexibility, and a user can conveniently use a format such as json to transmit information customized by the user. Actual steps are described below:

Information content is filled into a json file. For example, a user demands a program for play, and drags a player progress bar in the process, until the program directly jumps to a time point for watching. Information about this time point needs to be uploaded, so as to obtain a data packet from a specific position. Content of the json file generated based on the request is:

{“eventType”: “request_movie_by_time”, “movieID”: “123”, “time”: “17:50”}

Regarding this example, the value of the “PRR_type” field is set to “0”, the value of the “POST_serial_number” field is set to “111”, and the value of the “mime_type( )” field is set to a value corresponding to the type of the json file based on a mime standard.

This json file is used as a bit stream and is filled into a “PRR_data_byte” data segment of a message body, then the message is sent, and a specific message transmission bottom layer may be any adaptive protocol and physical layer.

After receiving the uploaded message, the server performs corresponding obtaining, and provides feedback information. The content of the feedback information is also organized by using the json format. For the downloaded message replied by the server, specific values are set as follows:

The value of the “PRR_type” field is set to “1”, the value of the “Response_number” field is set to “111”, the value of the “status number” field is set to “0x02”, and the value of the “mime_type ( )” field is set to a value corresponding to the type of the json file based on a mime standard. This json file is used as a bit stream and is filled into a “PRR_data_byte” data segment of a message body, then the message is sent.

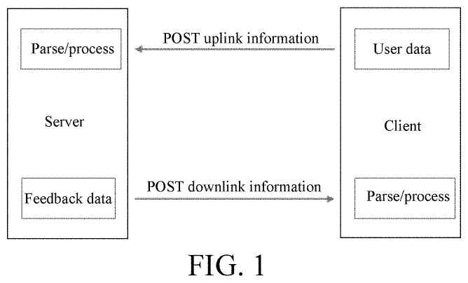

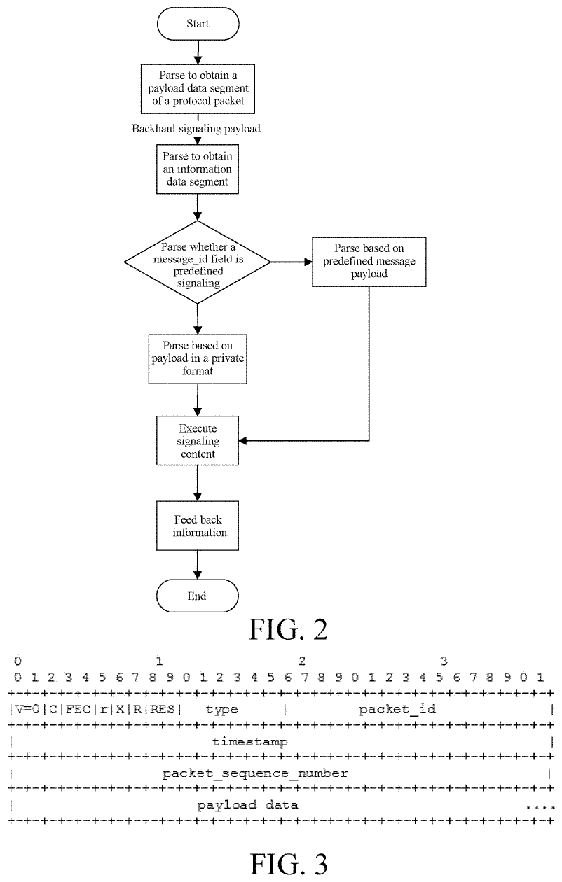

Reference may be made to FIG. 1 for this flow.

The information interaction manner by using a non-standard information format requires constant repeated development for different servers and clients. By using the present invention, the complexity of constructing a multimedia transmission network can be effectively reduced through the standardization of the information format.

It should be understood that only some of the embodiments of the present invention are described above, and the present invention may also be applied to other transmission systems, provided that network interaction information data needing to be transmitted is extracted for a specific service requirement, the information data is filled into the “PRR_data_byte” data segment in “payload” of the message, and then steps described in the network transmission method for interaction information data are performed. It is easy for a person skilled in the art to understand this based on the technical solutions described in the present invention.

### Embodiment 2

This embodiment provides another quick information interaction mechanism in a multimedia transmission system; the size of protocol format header data is simplified for a simplest data packet forced by a protocol transmission format, so that the protocol format is adapted to quick information interaction, and a quick information interaction format and a bidirectional resource quick request response message format are further designed in a targeted manner, and the formats can be applied to all media transmission systems; in addition, a corresponding network transmission method is provided, so that the data format in quick information interaction is applied, to resolve the defect that there is no efficient bidirectional quick information interaction mechanism in existing media transmission systems.

Some embodiments are provided below to describe implementation details of this embodiment by using examples.

(1) Protocol Improvement

The protocol format of interaction information in this embodiment improves the MMTP protocol, so that the MMTP protocol is more adapted to efficient and quick network information interaction, and the application range is enlarged to all media transmission systems, rather than limited to the MMTP protocol.

In addition to optional fields, the simplest data packet forced by the MMTP original protocol transmission format includes the following fields:

a field for identifying a protocol version-“V”;

a flag field for identifying whether a “packet_counter” data segment exists-“C”;

a flag field for identifying whether an “FEC” (forward data error correction) data segment exists-“FEC”;

a flag field for identifying whether an extension header data segment exists-“X”;

a flag field for identifying whether the payload information content has a characteristic of a random access point-“R”;

reserved fields-“r” and “RES”;

a flag field for identifying a payload information type-“Type”;

a Packet_id identification field;

a Timestamp timestamp field; and

a Packet_sequence_number sequence number identification field.

The byte format thereof may be represented, as shown in FIG. 3.

In this embodiment, with respect to the requirement for efficient and quick information interaction, reserved fields (that is, r, and RES fields) in the original format are used as flag bits, and choices of simplifying three fields: Packet_id, Timestamp, and Packet_sequence_number are provided, thereby effectively simplifying the size of the protocol format header data.

The Original Reserved Field Position r (1 Bit) is Modified as a T Identification Field:

T: timestamp_flag; if T is set to 1, a timestamp field is used, and if T is set to 0, the timestamp field is not used. When interaction information has strong instantaneity, that is, once a client or a server end receives the information, a response is made, the field may be set to 0, and the precondition is providing a reliable underlying communication protocol.

The Original Reserved Field Position RES (2 Bits) is Modified as P and F Identification Fields (1 Bit Each):

P: packet_id_flag; if P is set to 1, the packet_id field is used; and if p is set to 0, the packet_id field is not used. When the amount of payload information is relatively small and a data packet can be placed for transmission, or when a data packet is delivered to the underlying protocol for implementation, the field may be set to 0, and the precondition is providing a reliable underlying communication protocol.

F: fragmentation_flag; if F is set to 1, the packet_sequence_number field is used; and if F is set to 0, the packet_sequence_number is not used. The field is usually used in combination with the “P” field; when the condition of setting the “P” field to 0 is met, this field may also be set to 0.

In combination with the mandatory fields of the original MMT, the simplified minimum data header format is shown in FIG. 5.

Apparently, in the simplified simplest protocol format, the number of bytes is greatly reduced, thereby improving the speed of network transmission.

To better keep the compatibility, a message entity that performs quick interaction may be transmitted in a signaling mode of the MMTP, and the header data format of the existing payload of the MMT is provided herein as follows (as shown in FIG. 7):

A data header part of the MMTP signaling mode includes the following fields: a field for identifying fragment aggregation-“f_i”;

a field for identifying whether a data segment includes only one piece of signaling-“A”;

a field for identifying the number of remaining fragments for reception and combination-“frag_counter”;

a reserved field-“res”;

a field for identifying an information length and a field length-“H”; and

a field for identifying an information length-“MSG_length”.

It needs to be emphasized again that this embodiment is not limited to the application scenario of the MMT protocol. Due to the flexible customizability of the format of the payload data segment (payload) of the message body, the message mechanism of this embodiment can be theoretically applicable to information interaction transmission of any media system.

(1) Quick Interaction Information Body Format

The quick interaction information body includes the following fields:

a message identification field of a real-time interaction message;

a version number field of a message;

a message length identification field;

an extension field; and

a data segment identifying current message payload.

In a specific implementation, the following formats may be used:

| | | | |
|---|---|---|---|
| Syntax | Value | Bit number | Format |

| | | |
|---|---|---|
| message ( ) { | | |
| message_id | 16 | uimsbf |
| version | 8 | uimsbf |
| length | 16/32 | uimsbf |
| extension | | |
| message_payload { | | |
| } | | |
| } | | |

More specifically, the different types of message payload have different specific formats, and it can also be learned that in this embodiment, various message requirements can be flexibly and efficiently compatible. In an implementation, the following message payload specific formats may be used:

1) Definition of Real-Time Interaction Message Payload

A real-time interaction message (RIC_message) is used for transmitting real-time interaction data. The main characteristics of the message are a small data volume of the message and a high frequency, so that requirements of some scenarios having relatively high requirements for uploading real-time performance can be satisfied. A common format thereof is predefined, and presetting the definition of a specific message format should also be considered as a part of this embodiment.

The real-time interaction message payload includes the following fields:

an extended flag bit field, used for indicating whether a current message signaling payload part includes an extensible data part;

a field identifying the number of pieces of interaction data included in the message signaling;

a type identifying current interaction information;

a field identifying a length of current interaction data;

a byte data segment identifying the current interaction information; and

a data format data segment for user definition or further extension.

For the structure of the entire data format, reference may be made to the following real-time interaction message format table:

Real-time interaction message format table

| | | Bit | |
|---|---|---|---|
| Syntax | Value | number | Format |
| RIC_message( ){ | | | |
| message_id | | 16 | uimsbf |
| version | | 8 | uimsbf |
| length | | 16 | uimsbf |
| extention { | | | |
| reserve | ‘111 1111’ | 7 | bslbf |
| extention_flag | | 1 | boolean |
| } | | | |
| message_payload { | | | |
| number_of_interaction_data | | 8 | uimsbf |
| for(j = 0; j < N1; j++) { | N1 | | |
| interaction_data_type | | 16 | uimsbf |
| interaction_data_length | | 16 | uimsbf |
| for(j = 0; j < N2; j++) { | N2 | | |
| interaction_data_byte | | 8 | uimsbf |
| } | | | |
| } | | | |
| if(extention_flag == 1) { | | | |
| extention_field_byte | | | |
| } | | | |
| } | | | |
| } | | | |

2) Definition of Resource Request Response Message Payload

The main characteristics of a resource request response message (3R_message) are session-type interaction, and that a user request and a system response format are organically unified. The present message absorbs the design idea and the advantage of an http protocol mechanism, and a brand new design is made for the widest application in a media network, that is, network interaction performed when the client obtains a resource from the server. In this way, a server and a client supporting the mechanism can implement the multimedia-oriented lightweight interaction application of the resource request response type even without the interface of the http protocol. This brings enormous convenience to media network transmission.

FIG. 6 is a schematic diagram of application of a resource request response message, which includes the following fields:

a resource request method identification field, used for indicating a method for requesting for a resource by a current user, where type values and descriptions are shown in the following table; and

| Value | Description |
|---|---|
| 00b | “REQUEST_GET” |
| 01b | “REQUEST_POST” |
| 10b | “RESPONSE_GET” |
| 11b | “RESPONSE_POST” |

an extended flag bit field, used for indicating whether a current message signaling payload part includes an extensible data part.
More specifically, in the form in which corresponding “REQUEST_GET” is assigned to the field identifying the type of a method in which a current user requests for a resource, the following fields are included:

a field of a length of URL information of a resource requested by a user in a GET manner; and

a field of specific content of a URL of a resource requested by a user in a GET manner.
More specifically, in the form in which corresponding “REQUEST_POST” is assigned to the field identifying the type of a method in which a current user requests for a resource, the following field is included:

a field identifying a data type of a resource requested by a current user in a POST manner, where type values and descriptions are shown in the following table:

| Value | Description |
|---|---|
| 0x0000 | Asset/Asset_edit |
| 0x0001 | MPU |
| 0x0002 | MPU header data |
| 0x0003 | MPU media entity data |
| 0x0004 | Signaling data |
| 0x0005 | Database data |
| 0x0006 | General file |
| 0x0007 to 0x7FFF | Reserved for ISO |
| 0x80000 to 0xFFFF | Reserved for private |

More specifically, when “0x0000” is assigned to the field identifying a data type of a resource requested in a POST manner, the following fields are included:

a field identifying a unique Asset identification number of a requested resource, used for positioning a requested media resource, where a definition thereof is obtained based on ISO/IEC 23008-1; and

a field identifying an Asset edit number requested by a current message, where different edit numbers correspond to different edit versions of a media resource, an MPU list relationship included therein may be obtained from related descriptions, the value of the edit_id field of a complete version is 0 by default, and if the protocol does not support the edit number manner, the field is also set to 0.

More specifically, when “0x0001”, “0x0002”, or “0x0003” is assigned to the field identifying a data type of a resource requested in a POST manner, the following fields are included:

a field identifying a unique Asset identification number of a requested resource, used for positioning a requested media resource, where a definition thereof is obtained based on ISO/IEC 23008-1; and

a field identifying a unique sequence number of a media processing unit in a media resource, for positioning a specific media processing unit, where a definition thereof is obtained based on ISO/IEC 23008-1.

More specifically, when “0x0004” is assigned to the field identifying a data type of a resource requested in a POST manner, the following fields are included:

a field identifying a unique identification number of a resource set package, where a definition thereof is obtained based on ISO/IEC 23008-1;

a field identifying a unique identification number of an information type of signaling related to the resource set, used for identifying the type of the signaling, where a definition thereof is obtained based on ISO/IEC 23008-1; and

a field identifying a version number of signaling information related to the resource set, used for identifying an updated version of signaling, where a definition thereof is obtained based on ISO/IEC 23008-1.

More specifically, when “0x0005” is assigned to the field identifying a data type of a resource requested in a POST manner, the following fields are included:

a field uniquely identifying an identification number of a user account, for positioning a specific user account;

a field for identifying a type of an uploaded database, for describing the type of a database, where correspondence between specific values and types may be defined based on application;

a field identifying a data version of the uploaded database, used for maintaining and updating a user database in a server;

a field for identifying a length of a data segment of the uploaded database; and

a field identifying the data segment of the uploaded database.

More specifically, when “0x0006” is assigned to the field identifying a data type a resource requested in a POST manner, the following fields are included:

a field identifying an MIME type of a general file uploaded by a user, used for instructing a server to parse data based on a corresponding file format;

a field for identifying a length of a data segment of the uploaded general file; and

a field of the data segment of the uploaded general file.
More specifically, in the form in which corresponding “RESPONSE_GET” is assigned to the field identifying the type of a method in which a current user requests for a resource, the following field is included:

a field describing a return state of a server, where values and descriptions thereof are shown in the following table:

| Value | Description |
|---|---|
| 0x00 | The request fails, and a resource expected |
| | to be obtained by the request is not found |
| | on a server |
| 0x01 | The request has succeeded |
| 0x02 | The request has succeeded, and a response |
| | header or data body expected by the request will |
| | be returned with the response |
| 0x03 | The request has succeeded, and a response |
| | header or data body expected by the request will |
| | be returned in flow payload of a |
| | specific packet_id |
| 0x04 to 0x7F | Reserved for ISO |
| 0x80 to 0xFF | Reserved for private use |

More specifically, in the form in which “0x02” is assigned to the field identifying the return state of the server, the following fields are included:

a field indicating an MIME type of data that is requested by a user and that is returned by a server, where a client is pre-notified of checking, in advance, whether the resource can be consumed;

a field of a byte length of returned content; and

a field identifying a data segment of the returned content.
More specifically, in the form in which corresponding “RESPONSE POST” is assigned to the field identifying the type of a method in which a current user requests for a resource, the following field is included:

a field describing a return state of a server, where values and descriptions thereof are the same as those shown in the foregoing table.

More specifically, in the form in which “0x03” is assigned to the field identifying the return state of the server, the following fields are included:

a field uniquely identifying a transmission packet number, where values thereof have one-to-one correspondence with Asset_id values, and a definition thereof is obtained based on ISO/IEC 23008-1; and the field is used for indicating a transmission packet where a returned resource is located; and

a data segment for user definition or further extension.

For the structure of the entire data format, reference may be made to the following resource request response message format:

Resource request response message format table

| Syntax | Value | Bit number | Format |
|---|---|---|---|
| 3R_message ( ) { | | | |
| message_id | | 16 | uimsbf |
| version | | 8 | uimsbf |
| length | | 16 | uimsbf |
| extention { | | | |
| reserved | ‘1 1111’ | 5 | bslbf |
| method | | 2 | bslbf |
| extention_flag | | 1 | boolean |
| } | | | |
| message_payload { | | | |
| if(method == REQUEST_GET) { | | | |
| URL_length | N1 | 8 | uimsbf |
| for(j == 0; j < N1; j++) { | | | |
| URL_byte | | 8 | uimsbf |
| } | | | |
| } else if(method == REQUEST_POST) { | | | |
| resource_type | | 8 | uimsbf |
| if(resource_type == 0x00) { | | | |
| asset_id( ) | | | |
| edit_id | | 8 | uimsbf |
| } else if(resource_type == 0x01 \|\| | | | |
| resource_type == 0x02 \|\| resource_type == | | | |
| 0x03) { | | | |
| asset_id( ) | | 32 | uimsbf |
| mpu_sequence_number | | | |
| } else if(resource_type == 0x04) { | | | |
| MMT_package_id( ) | | 16 | uimsbf |
| message_id | | 8 | uimsbf |
| version | | | |
| } else if(resource_type == 0x05) { | | 32 | uimsbf |
| user_account_id | | 16 | uimsbf |
| database_type | | 8 | uimsbf |
| database_version | N2 | 16 | uimsbf |
| data_length | | | |
| for(j == 0; j < N2; j++) { | | 8 | uimsbf |
| data_byte | | | |
| } | | | |
| } else if(resource_type == 0x06) { | | | |
| mime_type( ) | | | |
| file_length | N3 | 40 | uimsbf |
| for(j == 0; j < N3; j++) { | | | |
| file_byte | | 8 | uimsbf |
| } | | | |
| } | | | |
| } else if(method == RESPONSE_GET) { | | | |
| status_number | | 8 | uimsbf |
| if(status_number == 0x02) { | | | |
| mime_type( ) | | | |
| content_length | N4 | 32 | uimsbf |
| for(j == 0; j < N4; j++) { | | | |
| content_byte | | 8 | uimsbf |
| } | | | |
| } | | | |
| } else if(method == RESPONSE_POST) | | | |
| { | | 8 | uimsbf |
| status_number | | | |
| if(status_number == 0x03) { | | 16 | uimsbf |
| packet_id | | | |
| } | | | |
| } | | | |
| if(extention_flag == 1) { | | 8 | uimsbf |
| extention_field_byte | | | |
| } | | | |
| } | | | |
| } | | | |

3) Implementing Steps of Message Interaction

The network transmission method for interaction information data provided in this embodiment includes the following steps:

Step a: A network terminal device encapsulates a message body “payload” field based on a pre-defined format of a quick interaction message payload data segment (payload) or a user-defined payload format of the message body.

Step b: The network terminal device encapsulates the entire message based on a quick interaction message body format.

Step c: The network terminal device encapsulates the message into the protocol “payload” based on a definition of an MMT (ISO/IEC 23008-1) original protocol “payload” format.

Step d: The network terminal device generates one or more packet network transmission data packets based on the protocol format.

Step e: After receiving packet data packets submitted by one or more clients, the network server obtains, based on protocol headers of the data packets, a complete protocol level “payload” data segment.

Step f: The network server obtains, based on the format of the protocol “payload”, a complete message body data segment.

Step g: The network server obtains, based on a definition of a message header, a “payload” data segment of the message body.

Step h: The network server parses the message “payload” data segment based on a message-defined or user-defined format, and performs corresponding processing and responses.

Communication from a server end to the network terminal device also follows the steps. The data format and application method satisfy the requirement of network bidirectional communication.

Further, in an implementation, the network transmission method for message data in this embodiment is applied between a network terminal device and a network server.

1) Feeding Back a Real-Time Interaction Message of Specific Data

A specific use method for transmitting, by using a type of the quick interaction data, data of a mouse, a keyboard, and the like that needs to be fed back in real time to a server in a cloud desktop application is described below:

determining a field value in the following manner:

using a message identifier field, and taking a specific value to indicate that the transmitted data is used for transmission of interaction data;

using a version in a message to indicate a sequence number of current time data within the time, and each time a message is updated, adding 1 to this field value, and after a full value is achieved, resetting the field value to 0 in a next round; and using a message data type in the message to indicate different types of real-time interaction events of a mouse, a keyboard, or the like.

Refer to Table 1 for selection of a corresponding interaction data type.

TABLE 1
Real-time interaction information data
type (interaction_data_type)

| Value | Description |
|---|---|
| 0x0000 | Indicating that a key of a keyboard is pressed |
| 0x0001 | Indicating that a key of the keyboard is released |
| 0x0002 | Indicating an indicator key state in the keyboard |
| 0x0003 | Indicating that a mouse is at an absolute location |
| | of a display screen |
| 0x0004 | Indicating a movement operation of the mouse |
| 0x0005 | Indicating that a key of the mouse is pressed |
| 0x0006 | Indicating that a key of the mouse is released |
| 0x0007 to 0x7FFF | Reserved for ISO |
| 0x80000 to 0xFFFF | Reserved for private |

The size of data corresponding to a current event is indicated by using a length of interaction data in a message, and data definitions of corresponding interaction data are shown in Table 2:

TABLE 2
Definitions of interaction data used for transmitting
messages of a mouse and a keyboard

| | | Corresponding interaction_data_byte definition | | |
|---|---|---|---|---|
| | Description | | Bit | |
| interaction_data_type | of a data type | Description | number | Use method |
| 0x0000 | Indicating that | KeyCode | 32 | Scan code |
| | a key of a | | | corresponding to |
| | keyboard is | | | the keyboard |
| | pressed | | | |
| 0x0001 | Indicating that | KeyCode | 32 | Scan code |
| | a key of the | | | corresponding to |
| | keyboard is | | | the keyboard |
| | released | | | |
| 0x0002 | Indicating an | Keyboard_led | 32 | Indicating states of |
| | indicator key | | | three keyboard |
| | state in the | | | indicators by using |
| | keyboard | | | a combination |
| 0x0003 | Indicating that | x | 32 | A mouse cursor is |
| | a mouse is at | | | at a location of the |
| | an absolute | | | x axis |
| | location of a | y | 32 | The mouse cursor |
| | display screen | | | is at a location of |
| | | | | the y axis |
| | | buttons_state | 32 | Indicating mask |
| | | | | states of left, |
| | | | | middle, and right |
| | | | | keys of the current |
| | | | | mouse by using a |
| | | | | combination |
| 0x0004 | Indicating a | x | 32 | Movement distance |
| | movement | | | of the mouse on the |
| | operation of | | | x axis |
| | the mouse | y | 32 | Movement distance |
| | | | | of the mouse on the |
| | | | | y axis |
| | | button_state | 32 | Indicating mask |
| | | | | states of left, |
| | | | | middle, and right |
| | | | | keys of the current |
| | | | | mouse by using a |
| | | | | combination |
| 0x0005 | Indicating that | button_id | 32 | Indicating |
| | a key of the | | | operations of |
| | mouse is | | | pressing left, |
| | pressed | | | middle, and right |
| | | | | keys of the mouse |
| | | | | and upward and |
| | | | | downward sliding |
| | | | | of a mouse wheel |
| | | button_state | 32 | Indicating mask |
| | | | | states of left, |
| | | | | middle, and right |
| | | | | keys of the current |
| | | | | mouse by using a |
| | | | | combination |
| 0x0006 | Indicating that | button_id | 32 | Indicating an |
| | a key of the | | | operation of |
| | mouse is | | | releasing left, |
| | released | | | middle, and right |
| | | | | keys of the mouse |
| | | button_state | 32 | Indicating mask |
| | | | | states of left, |
| | | | | middle, and right |
| | | | | keys of the current |
| | | | | mouse by using a |
| | | | | combination |

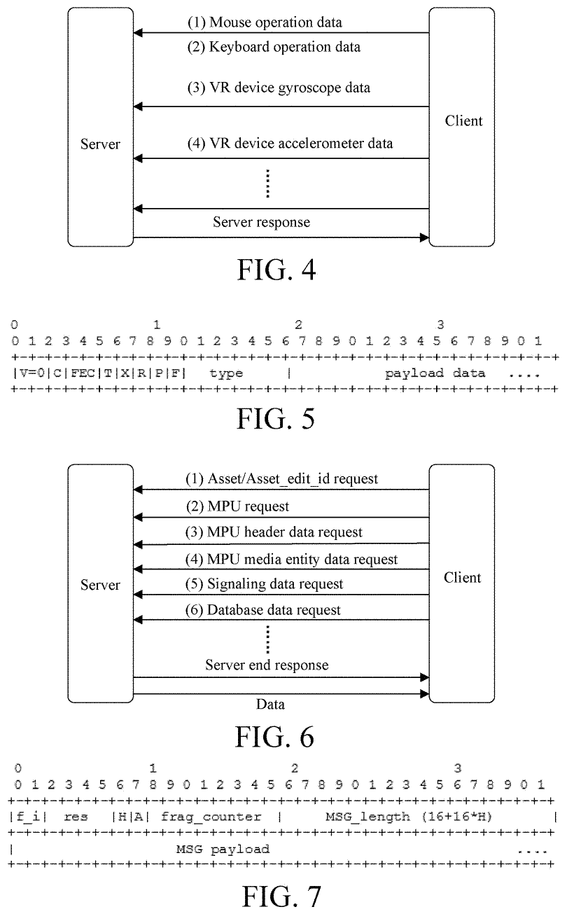

Then data segments are sequentially filled based on the structure in FIG. 4. After a complete message “payload” data segment is filled, the message is sent based on the foregoing “implementing steps of message interaction”.

Transmission of a rich variety of uplink data on a virtual reality device such as gyroscope data, accelerometer data, magnetic compass data, joystick data, tactile feedback data, and force feedback data in a media system can be implemented by defining a corresponding interaction data type and interaction data format.

2) Transmitting Content of a Message in a User-Defined jSon Format by Using a Message Format of this Embodiment

This embodiment has good scalability and flexibility, and a user can conveniently use a format such as json to transmit information customized by the user. Actual steps are described below:

Referring to Table 3, an undefined private field reserved value is selected as a message identifier value of a current message.

TABLE 3
Predefined values of message identifiers

| Value | Description |
|---|---|
| 0x0000 | PA message |
| 0x0001 to 0x000F | MPI message |
| 0x0010 to 0x001F | MPT message |
| 0x0200 | CRI message |
| 0x0201 | DCI message |
| 0x0203 | AL_FEC message |
| 0x0204 | HRBM message |
| 0x0205 | MC message |
| 0x0206 | AC message |
| 0x0207 | AF message |
| 0x0208 | RQF message |
| 0x0209 | ADC message |
| 0x200A | RIC message |
| 0x020B | 3R message |
| 0x020A to 0x6FFF | Reserved based on an ISO standard |
| | (16-bit length message) |
| 0x7000 to 0x7FFF | Reserved based on an ISO standard |
| | (32-bit length message) |
| 0x8000 to 0xFFFF | Reserving a private field used for |
| | user extension |

Information content is filled into a json file. For example, a user demands a program for play, and drags a player progress bar in the process, until the program directly jumps to a time point for watching. Information about this time point needs to be uploaded, so as to obtain a data packet from a specific position. Content of the json file generated based on the request is:

{“eventType”: “request_movie_by_time”, “movieID”: “123”, “time”: “17:50”}

This json file is used as a bit stream and is filled into a “payload” data segment of a message body, and then the message is sent based on the foregoing “implementing steps of message interaction”.

The information interaction manner by using a non-standard information format requires constant repeated development for different servers and clients. By using this embodiment, the complexity of constructing a multimedia transmission network can be effectively reduced through the standardization of the information format. In addition, improvements made to the protocol can greatly improve the performance of network information interaction. In particular, when a network bandwidth is crowded, user satisfaction is greatly improved.

In the quick information interaction mechanism in a multimedia system provided in this embodiment, the size of protocol format header data is mainly simplified, so that the protocol format is adapted to quick information interaction, and a message interaction format and a message interaction method are further designed in a targeted manner, so that the mechanism is applicable to all media transmission systems.

It should be understood that only some of the embodiments of the present invention are described above, and this embodiment may also be applied to other transmission systems, provided that network interaction information data needing to be transmitted is extracted for a specific service requirement, the information data is filled into the “payload” data segment of the message, and then steps described in the network transmission method for interaction information data are performed. It is easy for a person skilled in the art to understand this based on the technical solutions described in this embodiment.

The foregoing two embodiments implement two different forms of overall network transmission methods and mechanisms for interaction information data in a multimedia system. In Embodiment 2, the size of specific protocol format header data in a transmission mechanism is simplified, and flag bits indicating whether the three fields: Packet_id, Timestamp, and Packet_sequence_number are used are provided, so that the number of bytes of the protocol format header data becomes smaller; in Embodiment 1 and Embodiment 2, different tasks are completed by designing messages of different types, such as a real-time interaction message, responsible for transferring interaction operation information, and a response request response message, responsible for interaction with a server, requesting for a resource, or uploading data, and encapsulating a specific message into the following formats: an interaction message format (PRR), a resource request response message format (3R), and a real-time interaction message format (MC), to finally overcome the defect that there is no efficient bidirectional quick information interaction mechanism in existing media transmission systems.

### Embodiment 3

This embodiment provides an optimized transmission mechanism for a still image in a video stream.

In this embodiment, in a header or signaling of video transmission, such as an MMTP header or a DU header, a still frame flag bit is disposed to indicate that video data payload carried in the data packet is empty, and frame data corresponding thereto is the same as that of a previous frame. A newly added flag bit may be placed at locations such as the MMTP header, DU header, or signaling, and two specific solutions are provided below.

1. One Bit is Taken from a Reserved Field of an MMTP Header as a Still Frame Flag Bit, for Indicating that Frame Data Corresponding to a Current MMTP Packet is the Same as that of a Previous Frame.

To consider the compatibility of an existing system, one bit of a reserved field of the MMTP header is taken as a flag bit, for indicating that the video frame data corresponding to the MMTP packet is the same as that of the previous frame.

The reserved field in the MMTP packet header defines static_frame_flag, specifically:

static_frame_flag (S): for indicating whether frame data corresponding to a current data packet is a still frame; if the field is set to 0, it indicates that the frame data corresponding to the data packet is not a still frame, and payload is not empty, and if the field is set to 1, it indicates that the frame data corresponding to the data packet is a still frame, and payload of the data packet is empty.

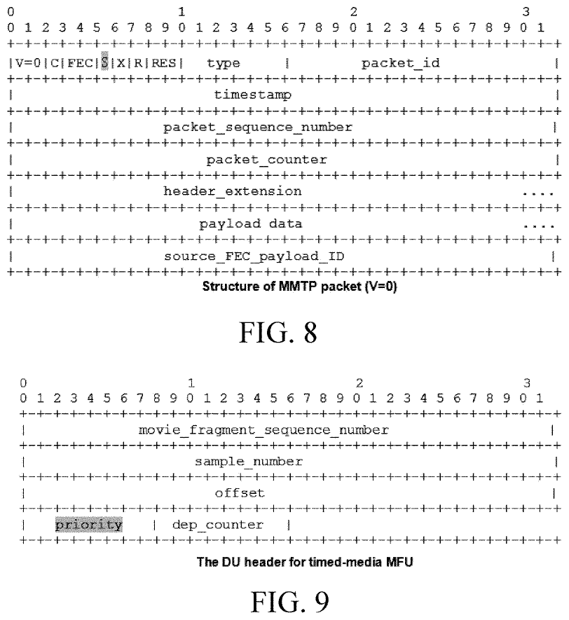

The position of the newly defined static_frame_flag in the MMTP header is as follows: the fifth bit in the MMTP header, as shown in FIG. 8.

A step of reducing, by using a still frame flag bit, bandwidths and data traffic used in a transmission process is provided below by using taking one bit from a reserved field in an MMTP header as a still frame flag bit as an example:

S1: A server end compares front and rear images of video data that is not encoded, to obtain a corresponding data frame when a video image is still.

S2: The server encodes the video data, to obtain frame data after encoding.

S3: When encoded data is packaged into an MMTP, if a frame is identified as a still frame in S1, set a static_frame_flag (S) field in a corresponding MMTP packet to 1, indicating that frame data corresponding to the data packet is a still frame, and payload of the data packet is empty, where processing manners of other non-still frames do not change.

S4: A receiving end parses the received MMTP packet, and if the static_frame_flag (S) field is 0, feeds the frame data to a decoder, and if the static_frame_flag (S) field is 1, the receiving end does not feed data to the decoder, and directly repeats a decoding result of a previous frame of the decoder to reconstruct an image.

2. A Priority Field in a DU Header is Used, and a Specific Value is Taken to Indicate that Frame Data Corresponding to a Current MMTP Packet is the Same as that of a Previous Frame.

The priority field in the DU header is used to describe a priority of a video frame carried in the data unit in a media unit, and in use, the field is set to “all 0”, to indicate that the frame data corresponding to the DU header is the same as that of the previous frame, and payload is empty. The position of the priority field in the standard is shown in FIG. 9.

A step of reducing, by using a still frame flag bit, bandwidths and data traffic used in a transmission process is provided below by using that a priority field in a DU header is used for indicating a flag bit as an example:

S1: A server end compares front and rear images of video data that is not encoded, to obtain a corresponding data frame when a video image is still.

S2: The server encodes the video data in a corresponding video coding manner, to obtain frame data after encoding.

S3: When encoded data is packaged into an MMTP, if a frame is identified as a still frame in S1, set a priority value of a DU header in a corresponding MMTP packet to “all 0”, where content of DU payload is empty, and processing manners of other non-still frames do not change.

S4: A receiving end parses the received MMTP packet, and if the priority field is not “all 0”, feeds the frame data to a decoder, and if the priority field is “all 0”, the receiving end does not feed data to the decoder, and directly repeats a decoding result of a previous frame of the decoder to reconstruct an image.

The foregoing embodiments are merely some of the implementations of this embodiment. According to this embodiment, a corresponding still frame flag bit may also be disposed in signaling or a header in other cases, and use of network bandwidths is reduced by using a method in which only the flag bit is transmitted but corresponding frame data is not transmitted, so as to resolve the problem of bandwidth occupation and traffic waste brought by a still image frame in streaming media video transmission.

The specific embodiments of the present invention are described above. It should be understood that the present invention is not limited to the foregoing specific implementations, and a person skilled in the art can make various transformations or modifications within the scope of the claims, and this does not affect the substantive content of the present invention.

1. A multimedia system information interaction mechanism, wherein the mechanism implements bidirectional quick interaction by using the following information, wherein the information comprises:
a message identification field for identifying an identification code of a message;
a message version number field for identifying a version number of the message;
a message length identification field for identifying a length of the message; and
a payload data segment, comprising and identifying payload data of the message.

2. The multimedia system information interaction mechanism, as recited in claim 1, wherein the payload data segment comprises a message content category identification field at least for identifying whether the message is located on an uplink or a downlink between a server and a client.

3. The multimedia system information interaction mechanism, as recited in claim 1, wherein the payload data segment further comprises a reserved field at least for identifying an information reservation function.

4. The multimedia system information interaction mechanism, as recited in claim 2 further comprising a reserved field, at least for identifying an information reservation function, wherein a bit length of the reserved field is determined based on a bit number difference between an integer multiple of a bit number within a byte and a bit number of the message content category identification field.

5. The multimedia system information interaction mechanism, as recited in claim 2, wherein the message content category identification field identifies the uplink or the downlink respectively by using different assigned values.

6. The multimedia system information interaction mechanism, as recited in claim 5, wherein the message content category identification field identifies the uplink by using an assigned value 0 and identifies the downlink by using an assigned value 1.

7. The multimedia system information interaction mechanism, as recited in claim 5, wherein when the message content category identification field is identified as an uplink state, the information comprises:
a message uplink sequence number identification field for identifying an uplink sequence number of the message;
an uplink byte data segment, comprising a byte stream currently interactively located in the uplink;
a content format field for identifying a format of the uplink byte data segment; and
a content length field for identifying a length of the uplink byte data segment.

8. The multimedia system information interaction mechanism, as recited in claim 5, wherein when the message content category identification field is identified as a downlink state, the information comprises:
a message downlink sequence number identification field for identifying a downlink sequence number of the message; and
a downlink byte data segment which is identified via a feedback state field and comprises a byte stream currently interactively located in the downlink state.

9. The multimedia system information interaction mechanism, as recited in claim 5, wherein a downlink sequence number and an uplink sequence number identified by the sequence number identification fields are associated with each other.

10. The multimedia system information interaction mechanism, as recited in claim 8, wherein the feedback state field identifies at least three feedback states correspondingly by using different assigned values; the feedback states comprise:
a first feedback state: an information uplink transmission failure which at least indicates that a reception is not completed within a preset time;
a second feedback state: an information uplink transmission success; and
a third feedback state: an information uplink transmission success, wherein the information comprises the byte stream in the downlink.

11. The multimedia system information interaction mechanism, as recited in claim 10, wherein “0X00” is assigned to the feedback state field in the first feedback state; “0X01” is assigned to the feedback state field in the second feedback state; and “0X02” is assigned to the feedback state field in the third feedback state.

12. The multimedia system information interaction mechanism, as recited in claim 10, wherein the feedback state field further identifies a reserved feedback state correspondingly by using different assigned values; and
the reserved feedback state comprises at least any one or two of International Organization for Standardization (ISO) standard reservations and private field reservations.

13. The multimedia system information interaction mechanism, as recited in claim 12, wherein “0X02 to 0X7F” are assigned to the feedback state field in the feedback state of the ISO standard reservations, and
“0X8F to 0XFF” are assigned to the feedback state field in the feedback state of the private field reservations.

14. The multimedia system information interaction mechanism, as recited in claim 10, wherein in the third feedback state, the downlink byte stream comprises:
a content of a currently interactive downlink byte stream;
a field for identifying a format of a content of the downlink byte stream; and
a field for identifying a length of the content of the downlink byte stream.

15. The multimedia system information interaction mechanism, as recited in claim 1, wherein the payload data segment comprises:
a message content category identification field;
a message sequence number field;
a sequence number field for identifying a particular message associated with the message;
a field for identifying a feedback state;
a byte data segment of current interaction information;
a field identifying a format of a content of the byte data segment; and
a field identifying a length of the content of the byte data segment.

16. The multimedia system information interaction mechanism, as recited in claim 1, wherein the information comprises:
the message identification field occupying a bit length of 16 and having a format of a first unsigned integer;
the message version number field occupying a bit length of 8 and having a format of a second unsigned integer;
the message length identification field occupying a bit length of 32 and having a format of a third unsigned integer;
a message content category identification field occupying a bit length of 1 and having a format of a first bit string;
a reserved field occupying a bit length of 7 and having a format of a second bit string;
a message uplink sequence number identification field occupying a bit length of 8 and having a format of a fourth unsigned integer;
a message downlink sequence number identification field occupying a bit length of 8 and having a format of a fifth unsigned integer;
a content length field occupying a bit length of 16 and having a format of a sixth unsigned integer;
a message downlink sequence number identification field occupying a bit length of 8 and having a format of a seventh unsigned integer;
a message uplink sequence number identification field occupying a bit length of 8 and having a format of a eighth unsigned integer; and
a downlink byte stream in a third feedback state, wherein a content length field of the downlink byte stream occupies a bit length of 16 and has a format of first unsigned data,
which identifies a content of the downlink byte stream, occupies a bit length of an integer multiple of 8, and has a format of second unsigned data.

17. The multimedia system information interaction mechanism, as recited in claim 16, wherein 1111111 is assigned to the reserved field.

18. A multimedia system information interaction network transmission method using the multimedia system information interaction mechanism according to claim 1, comprising the following steps of:
encapsulating a message into a data packet based on a preset message format by a terminal device;
transmitting the data packet to a network server; and
parsing the data packet to obtain a payload data, wherein the network server accordingly processes the data packet based on a preset message and responds to the terminal device;
wherein the foregoing corresponding steps are followed from the network server to the terminal device.

19. The multimedia system information interaction network transmission method, as recited in claim 18, wherein the preset message format comprises an international agreement standard and/or a user-defined standard.

20. The multimedia system information interaction network transmission method, as recited in claim 18, wherein the first step of encapsulating the message based on the preset message format by the terminal device further comprises following sub-steps of:
encapsulating an uplink byte stream based on a pre-customized format of a bit payload data segment or a user-defined format of the message by the terminal device; and
encapsulating an entire message based on the preset message format by the terminal device.

21. The multimedia system information interaction network transmission method, as recited in claim 20, wherein the format of the bit payload data segment is based on formats of an uplink byte stream data and a downlink byte stream data.

22. The multimedia system information interaction network transmission method, as recited in claim 18, further comprising a step of performing protocol encapsulation on the entire message based on a format of a selected network communication protocol by the terminal device.

23. The multimedia system information interaction network transmission method, recited in claim 18, wherein further comprising a data packet generation step after the protocol encapsulation is performed which comprises following sub-steps of generating one or more packet data packets based on a protocol format by the terminal device.

24. The multimedia system information interaction network transmission method, as recited in claim 18, wherein
the step of processing the data packet by the server comprises:
parsing a complete protocol level payload data segment based on protocol headers of the data packet after the server receives the data packet that is submitted by one or more clients.

25. The multimedia system information interaction network transmission method, as recited in claim 18, wherein the step of parsing the data packet by the server further comprises a step of obtaining a complete message based on definitions of a corresponding network communication protocol format and a payload format.

26. The multimedia system information interaction network transmission method, as recited in claim 18, wherein the step of parsing the received data package by the server further comprises the following sub-steps of:
parsing the data packet package based on a message header in the message to obtain a data comprised in a bit payload data segment of the message; and
parsing a payload data contained in the bit payload data segment based on a message-defined format or a user-defined format.
